(19) United States
(12) Patent Application Publication
(10) Pub. No.: US 2013/0104918 A1
(43) Pub. Date: May 2, 2013

(54) FILTER AND METHOD OF MAKING SAME

(71) Applicant: Creepservice Sarl, Bole (CH)

(72) Inventor: Mikhajlov Serguei, Bole (CH)

(73) Assignee: CREEPSERVICE SARL, Bole (CH)

(21) Appl. No.: 13/656,903

(22) Filed: Oct. 22, 2012

(30) Foreign Application Priority Data
Oct. 27, 2011 (EP) 11186884.0

(51) Int. Cl. A24D 3/02; A24D 3/06; B01D 39/18; B01J 19/08; B01D 39/20; B01D 39/16

(52) U.S. Cl. 131/331; 204/164; 204/165

(57) ABSTRACT

The present invention relates to a method of producing a filter for removing unwanted components in a fluid flow or a gas flow, as well as a filter obtainable by the method according to the invention. Furthermore, the present invention relates to the use of the filter according to the invention for removing unwanted components in a fluid flow or a gas flow. Moreover, the present invention relates to the use of the filter for the production of products containing filter materials, such as cigarettes, and the products per se.

The present invention relates to a method of producing a filter for removing unwanted components in a fluid flow or a gas flow, as well as a filter obtainable by the method according to the invention. Furthermore, the present invention relates to the use of the filter according to the invention for removing unwanted components in a fluid flow or a gas flow. Moreover, the present invention relates to the use of the filter for the production of products containing filter materials, such as cigarettes, and the products per se.

It is known to employ porous filter materials to retain unwanted impurities in a fluid flow or a gas flow, particularly in fluids to be cleaned, combustion gases and smokes. Porous filters are, for example, used in kitchen filters, such as water filters, in vacuum cleaners, in the field of chemical purification methods, in after-treatment of exhaust gases of combustion engines, such as a Diesel particle filter, and in the tobacco industry, e.g. for cigarettes and small cigars (in the following combined under the term “cigarette”).

In the case of cleaning exhaust gases from combustion engines, cigarettes, the filter is used to reduce the amount of soot, unburned carbon and other harmful chemicals, such as tar, thereby only letting pass desired substances. Especially in the field of cigarettes it is desired to use filters to reduce the amount of tar and harmful chemicals in tobacco smoke, letting pass a desired amount of nicotine and flavorful substances.

Filters for removing unwanted components from a fluid flow or a gas flow are made of a variety of adsorbing materials ranging from paper, asbestos and cellulose acetate in the case of chemical filters and cigarettes, as well as porous inorganic materials, such as ceramics and metals in the case of particle filters for exhaust gases of combustion engines.

In some applications various substances may be added to the filter, e.g. plasticizers, binders, combustion retardants and biodegradation promoters. It is, for instance, known to employ in cigarette filters a tow of natural fibers, like cotton, in an effort to improving the biodegrading of cigarette butts. Furthermore, it is also known, e.g. to include substances like activated carbon in cigarettes in order to enhance the adsorption potential.

As can be seen from the above, there is always a demand of providing new filter materials that are more effective in adsorbing unwanted or harmful components from fluids or gases.

The present invention therefore provides a method of producing a new filter for removing unwanted or harmful components in a fluid flow or a gas flow comprising the following steps:
(i) providing a porous filter material; and
(ii) exposing the filter material to a jet of atmospheric plasma.

A plasma jet is generally used in a variety of processes and material treatments like cleaning, disinfection, adhesion and bonding improvements, coating and oxide removing. A plasma is in general a state of matter similar to gas in which a certain portion of the particles are ionized. After, for instance, sufficient heating a gas dissociates its molecular bonds, rendering it into constituent atoms. However, further heating may also lead to ionization (a loss or gain of electrons) of the molecules or atoms of the gas, thus turning it into a plasma containing charged particles: positive ions and negative electrons. Beneath the production of a plasma by using heat, a plasma may be produced by means of radiation, such as laser radiation, electrostatic fields, electromagnetic fields and microwaves.

The plasma jet treatment is also advantageous since it removes all microparticles from the filter surface.

It is also important to adjust the parameters debit (speed of flow gas) and the length of the plasma jet to control the depth of penetration of the plasma jet into the filter material.

The physical parameters of plasmas range from “hot” plasmas having a high electronic and neutral temperature and a high concentration of charged species to “cold” plasmas having a neutral temperature at ambient temperatures or slightly higher, and with a lower concentration of free charges. Furthermore, a plasma may be produced at atmospheric pressure or in a partial vacuum.

A plasma produced in atmospheric pressure is an “atmospheric plasma” in the sense of the present invention. An atmospheric plasma is a plasma, wherein the pressure of the plasma is almost the same as that of the surrounding atmosphere. An atmospheric plasma is usually produced by excitation of a gas by means of an alternating or continuous current. A plasma jet is usually produced by means of a plasma tip. In the plasma tip a pulsed electric arc is produced by means of the discharge of high voltage (1-15 kV, 100 Hz-100 kHz) into a discharge space between two electrodes. A process gas passing through this discharge space is then excited and transferred into the plasma state. The plasma produced in this way is then led through a nozzle head to the surface of the objects to be treated in the form of a jet of atmospheric plasma.

The temperature of the jet of atmospheric plasma used in the process of the present invention preferably ranges from 0° C. to 100° C., more preferred 20° C. to 80° C. and most preferred 20° C. to 60° C.

The process gas used for the production of the jet of atmospheric plasma is preferably dry oil-free air, nitrogen, argon, helium, mixtures thereof or other gases, or a gas mixture comprising oxygen. It is even more preferred for the use in the present invention that the process gas is dry oil-free air or a gas mixture comprising oxygen. In other words, the atmospheric plasma is most preferably obtained by dry oil-free air or by a gas mixture comprising oxygen.

As mentioned above the jet of plasma used in the present invention is obtained by passing the process gas through a discharge space of a plasma head, wherein high voltage is discharged. By this, the process gas is partially ionized thereby forming the atmospheric plasma. FIG. 1 below shows a device which may preferably be used for the fabrication of the filter according to the invention.

In the present invention a plasma generator is preferably used which is driven by a direct current (DC). The power supply in the plasma generator is connected to an inner electrode. Furthermore, the plasma generator has an outer electrode. The space between the two electrodes is the discharge space mentioned above. The current provided to the inner electrode of the plasma generator preferably ranges from 0.1 to 1 kW. Several such kinds of plasma generators are commercially available on the market, such as for example “Super Jet” produced by the company SwissNanoCoat SA, Bôle, Switzerland, which may be used in the present invention.

The filter material used in step (b) of the process according to the invention may comprise/consist of an inorganic or an organic material, preferably an organic material.

The inorganic material may either be a ceramic or a metallic material. The ceramics used for filters, especially in the field of particle filters in the purification of exhaust gases, are preferably mullite, cordierite, silicon carbide (SiC) and aluminum titanate.

The organic material may preferably be a material, known essentially in the art useful as organic filter material such as cellulose acetate, cotton, polymer fibers, glass fibers, stone wool, etc. wherein cotton and cellulose acetate and its derivatives are particularly preferred.

Apart from the specific materials mentioned above, it is further preferred that the organic material is a polymeric organic material, in order to ensure that no parts of the materials are lost due to the filtration process. The filter material used in the process of the present invention is preferably in the form of a powder or of fibers. In case the filter material comprises or consists of an organic material, it is preferred that the organic material is in the form of fibers. It is even more preferred that the fibers of the filter material form together a sponge-like material.

Further to the organic or inorganic material mentioned above forming the matrix of the filter material, the filter material may comprise further compounds, such as plasticizers, triacetine (glycerol triacetate), binders, combustion retardants, biodegradation promoters and delustrants, such as titanium dioxide, preferably in the Anatas form.

The average pore size, of the filter material preferably ranges from 0.1 to 1000 nm, preferably 0.1 to 100 nm. The average pore size can be determined by pore filling with a mercury intrusion method according to DIN 66133.

The pore volume of the filter material is preferably in the range of from 1 to 500 cm³/g. The pore volume of the filter material can also be determined by pore filling with a mercury intrusion method according to DIN 66133.

In the process of the present invention the filter material is exposed to the jet of plasma, a so-called plasma flame, preferably for a time in the range of 0.1 sec. to 60 sec., 0.5 sec. to 30 sec. and most preferred 0.5 sec. to 5 sec., dependent of the intensity and quality of the plasma. It is most preferred that the treatment time is in the range of from 1 to 3 seconds.

Since it is not possible with known analytic methods to determine what happens by the plasma treatment of the filter material, but the filters obtained by the method according to the invention surprisingly exhibits a higher efficacy in filtration, the present invention also refers to the filter per se which is obtainable by the process of the present invention.

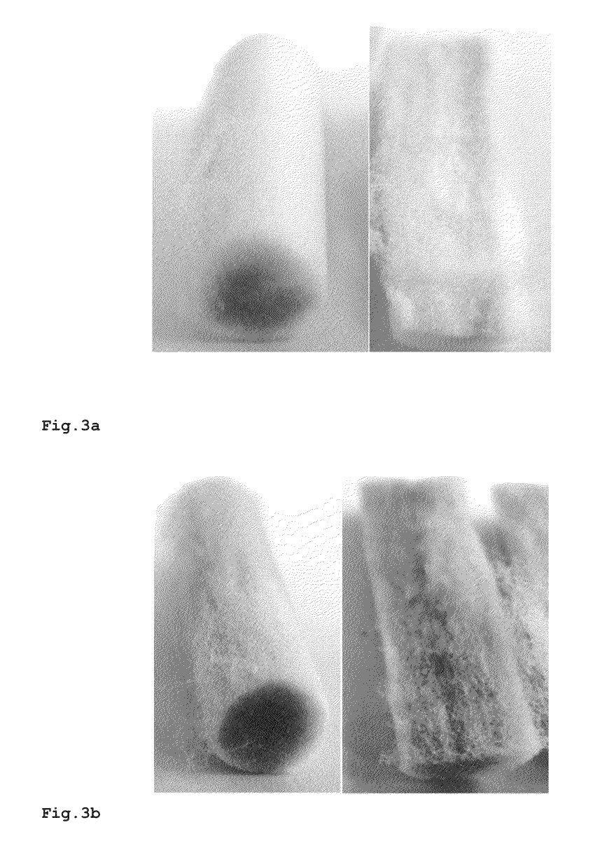

The effectiveness of the filter according to the invention has for instance been tested in smoking assays. After smoking, the filters have been weighed, opened and visually inspected. It was found that a treated filter retains more dark chemical compounds than untreated filters, and acquires more weight than untreated ones. It follows clearly that treatment of the invention imparts a higher filtering power to filters. The results of such tests can for example be seen by comparing the filter materials in FIGS. 3a and 3b below.

Furthermore, it has been found that filters treated according to the method of the invention used as cigarette filters allow the passage of flavorful substances and provide a rewarding smoking experience.

Without willing to be limited by theory, it is believed that the atmospheric plasma jet, within active radicals and charged ions, cleans the filter pores from any type of hydrocarbons or other pollutions that come from previous treatments. It seems to activate the surface (increase of surface energy) which results in a higher retention by the filter. Moreover, it could be possible that the treatment with an atmospheric plasma jet grafts radicals of the process gas (e.g. air) introduced in the plasma head to the surface of the filter material. These grafted molecules seem to react with molecules of a passing gas and produce a new quality of filters.

The present invention is also directed to the use of the filer according to the invention for removing unwanted components in a fluid flow or gas flow.

Furthermore, the present invention also relates to the use of the filter according to the invention for the production of a cigarette. That is, the present invention is also directed to the cigarette per se comprising the filter according to the invention.

The present invention is further explained by means of figures and examples below which should not be understood as limiting the scope of the present invention.

FIG. 1 represents a plasma generating device (10) which may be used for the process of the present invention. The device (10) shown in FIG. 1 is a generator of an atmospheric pressure plasma jet that generates a plasma jet by means of a plasma head that has an outer electrode (40) and an inner electrode (35) that define a discharge space (36) that is crossed by a gas flow (31). The process gas of the gas flow (31) flows through the line (31) and may preferably be air, nitrogen, argon, helium or other gases, if necessary with the admixture of oxygen. The inner electrode is connected to a suitable power supply (5) that provides for example 0.1 to 1 kW of direct current power, and a plasma flame is projected from the nozzle (41) and traverses the cigarette filter (45). The temperature of the flame is determined by the operating conditions, in particular the input gas temperature and the cooling of the plasma head which is not shown here, and will be kept within the safe limits for the material of the filter (45).

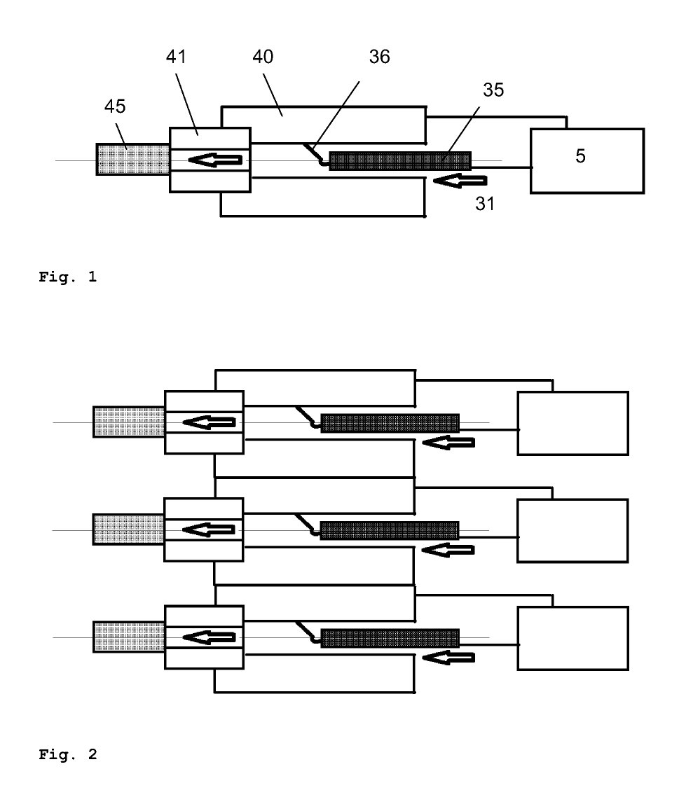

FIG. 2 shows schematically a variant of a device for carrying out the method according to the invention for producing a plurality of filters, using a device 20 essentially consisting of a plurality, here 3, devices 10. The reference numerals used are the same as in FIG. 1.

FIGS. 3a and 3b each are illustrating schematically and in section a filter obtainable according to the invention (3b) and a filter (3a) which has not been treated according to the invention after exposure to cigarette smoke.

### EXAMPLES

### Example 1

The filter of a cigarette of the brand Marlboro Red of Philip Morris Company has a weight of 145 mg in the unsmoked state. The filter has been treated for three seconds in an atmospheric plasma jet at a temperature of about 45° C. The generator of the plasma jet was a “Superjet” produced by the company Swissnanocoat SA, Bôle, Switzerland, wherein dry oil-free air has been taken as process gas and the DC supply was driven with a power of 3 kW. (see also FR 10/02650 and PCT/EP2011/060637 where the device is described in more details). The distance of the cigarette filter to the plasma head was about 1 cm.

The so treated filter was then put back in a Marlboro Red cigarette and ⅔ of the cigarette has been smoked. The filter put out of the cigarette then had a weight of 160 mg.

### Comparative Example 1

⅔ of a Marlboro Red cigarette has been smoked, wherein the filter was not treated by a jet of plasma. Before the cigarette was smoked, the filter had a weight of 154 mg. After the cigarette has been smoked, the weight of the filter was 157 mg.

By comparing the weight of the filter in Example 1 with the untreated filter in Comparative Example 1 it can be seen that the plasma-activated filter has a higher weight than the untreated filter. That is, the filter produced by the method according to the invention is able to filtrate more tar out of the smoke.

Furthermore, FIG. 3b shows the filter of Example 1 after smoking, and FIG. 3a shows the filter of Comparative Example 1 after smoking. The regions (48) indicate where the filter's fibers are darkened by the capture of tar, coal or other substances. It is apparent how the filter of FIG. 3b captures more dark substances, and the volume of the darkened parts is much higher. The regions are also much darker in filter (45) of FIG. 3b than in the filter of FIG. 3a, indicating again a superior activity of the filter according to the present invention.

### Comparative Example 2

Four pieces of cigarettes filters of the brand Dunhill light have been taken and weighed to a sum of 813 mg. The filters have been put back in the cigarettes and four cigarettes have been smoked in full length. After smoking the four cigarettes, the four filter pieces have been taken out of the cigarettes and have been weighed again. The weight of the four pieces of filters then was 959 mg. That is, the increase of the weight of the four filter pieces together was 146 mg resulting in an average increase of weight per filter of 36 mg.

### Example 2

Four pieces of filter of the brand Dunhill light have been taken out of a cigarette and have been weighed to 805 mg. The four filter pieces have been treated with a jet of atmospheric plasma in accordance with the treatment in Example 1. The four filter pieces have been put back into cigarettes and the cigarettes have been smoked in full length. The weight of the again out-taken filter pieces together was 986 mg. The increase of weight of the four filter pieces together after smoking was 181 mg. The increase of weight per cigarette in average was then 45 mg.

By comparing the increase of the used filters of Example 2 with the used filters in Comparative Example 2 shows that the plasma-treated filter is able to retain 25 percent more of the substances from the gas flow.

1. A method of producing a filter for removing unwanted or harmful components in a fluid flow or a gas flow comprising the following steps:
(i) providing a porous filter material; and
(ii) exposing the filter material to a jet of atmospheric plasma.

2. The method of claim 1, wherein said jet of atmospheric plasma has a temperature in the range of from 0° to 100° C.

3. The method of claim 1, wherein said jet of atmospheric plasma is obtained by dry oil-free air, argon, helium, nitrogen, mixtures thereof or a gas mixture comprising oxygen as process gas.

4. The method of claim 3, wherein the jet of atmospheric plasma is obtained by passing the process gas through a discharge space of a plasma head wherein high voltage is discharged.

5. The method of claim 1, wherein the filter material comprises an inorganic or an organic material.

6. The method of claim 5, wherein the organic filter material is a polymeric organic filter material.

7. The method of claim 6, wherein the polymeric organic filter material is cellulose acetate.

8. The method of claim 5, wherein the inorganic filter material is a ceramic or a metal.

9. The method of claim 1, wherein the filter material is in the form of a powder or of fibers.

10. The method of claim 1, wherein the filter material has an average pore size in the range of from 0.1 to 100 nm.

11. The method of any one of claims 1 to claim 10, wherein the filter material has a pore volume in the range of from 1 to 500 cm3/g.

12. A filter obtainable by a method according to claim 1.

13. Use of the filter according to claim 12 for removing unwanted components in a fluid flow or a gas flow.

14. Use of the filter according to claim 12 for the production of a cigarette.

15. A cigarette comprising the filter according to claim 12.
